(19) United States
(12) Patent Application Publication
(10) Pub. No.: US 2013/0237227 A1
(43) Pub. Date: Sep. 12, 2013

(54) METHOD AND SYSTEM FOR RESOURCE ALLOCATION BASED ON FEMTOCELL LOCATION CLASSIFICATION

(71) Applicant: QUALCOMM INCORPORATED, San Diego, CA (US)

(72) Inventors: Sumeeth NAGARAJA, San Diego, CA (US); Yeliz TOKGOZ, San Diego, CA (US); Mehmet YAVUZ, San Diego, CA (US); Farhad MESHKATI, San Diego, CA (US)

(73) Assignee: QUALCOMM INCORPORATED, San Diego, CA (US)

(21) Appl. No.: 13/787,768

(22) Filed: Mar. 6, 2013

Related U.S. Application Data
(60) Provisional application No. 61/609,172, filed on Mar. 9, 2012.

(51) Int. Cl. H04W 16/10

(52) U.S. Cl. CPC H04W 16/10
USPC 455/436; 455/452.1

(57) ABSTRACT

Disclosed are system and method for classifying an indoors location of a femtocell or femto node. In an aspect, the system and method are configured to perform, by a femto node, radio frequency (RF) measurements of one or more neighboring femtocells and macrocells; collect performance measurement reports from one or more mobile devices; classify the indoors location of the femto node based on the performed RF measurements and the collected performance measurement reports; and adjust one or more RF resources and parameters of the femto node based on the indoors location classification of the femto node.

### CLAIM OF PRIORITY UNDER 35 U.S.C. §119

The present application for patent claims priority to Provisional Applications No. 61/609,172 entitled “Method and System for Resource Allocation Based on Femtocell Location Classification” and filed on Mar. 9, 2012, and assigned to the assignee hereof and hereby expressly incorporated by reference herein.

### BACKGROUND

1. Field

This disclosure relates generally to the field of wireless communications, and more specifically to the system and methods for classifying an indoors location of a femtocell and allocating femtocell RF resources based on the indoors location.

2. Background

Wireless communication systems are widely deployed to provide various types of communication content such as, for example, voice, data, and so on. Typical wireless communication systems may be multiple-access systems capable of supporting communication with multiple users by sharing available system resources (e.g., bandwidth, transmit power, etc.). Examples of such multiple-access systems may include code division multiple access (CDMA) systems, time division multiple access (TDMA) systems, frequency division multiple access (FDMA) systems, orthogonal frequency division multiple access (OFDMA) systems, and the like. Additionally, the systems can conform to specifications such as third generation partnership project (3GPP), 3GPP long term evolution (LTE), ultra mobile broadband (UMB), evolution data optimized (EV-DO), etc.

Generally, wireless multiple-access communication systems may simultaneously support communication for multiple mobile devices. Each mobile device may communicate with one or more base stations (e.g., which can be commonly referred as macro nodes). To supplement conventional base stations, additional low power base stations (e.g., which can be commonly referred as femto nodes cells or pico nodes) can be deployed to provide more robust wireless coverage to mobile devices. For example, low power base stations can be deployed for incremental capacity growth, richer user experience, in-building or other specific geographic coverage, and/or the like.

Femto nodes are often installed by users in their homes, offices, buildings and other indoors environments without consideration of a current network infrastructure. The location of the femto node may be deep indoors within a building or close to a window or external wall. During operation, a femto node may select the same network resources (e.g., transmit power, frequency/time blocks, etc.) as other neighboring macro nodes or femto nodes, which may cause interference issues between neighboring macrocells and femtocells in high density macro node and femto node deployments. A femtocell is a coverage area of a femto node. Likewise, a macrocell is a coverage area of a macro node. Thus, improvements in the operation of femto nodes are desired.

### SUMMARY

The following presents a simplified summary of one or more aspects of systems, methods and computer program products for classifying an indoors location of a femtocell and allocating/adjusting resources and parameters of the femtocell based on the indoors location classification in order to optimize coverage by the femtocell and reduce interference with neighboring macro and femtocells. This summary is not an extensive overview of all contemplated aspects, and is intended to neither identify key or critical elements nor delineate the scope of any or all aspects thereof. Its sole purpose is to present some concepts of one or more aspects in a simplified form as a prelude to the more detailed description that is presented later

In one aspect, a method includes performing, by a femto node, radio frequency (RF) measurements of one or more neighboring femtocells and macrocells. The method further includes collecting performance measurement reports from one or more mobile devices. The method further includes classifying an indoors location of the femto node based on the performed RF measurements and the collected performance measurement reports. The method further includes adjusting one or more RF resources and parameters of the femto node based on the indoors location classification of the femto node.

In another aspect, a femto node apparatus includes a information collection component configured to perform RF measurements of one or more neighboring femtocells and macrocells, and to collect performance measurement reports from one or more mobile devices. The apparatus further includes a location classification component configured to classify an indoors location of the femto node based on the performed RF measurements and the collected performance measurement reports. Additionally, the apparatus includes an adjustment component configured to adjust one or more RF resources and parameters of the femto node based on the indoors location classification of the femto node.

In another aspect, a femto node apparatus includes means for performing RF measurements of one or more neighboring femtocells and macrocells. The apparatus further includes means for collecting performance measurement reports from one or more mobile devices. The apparatus further includes means for classifying an indoors location of the femto node based on the performed RF measurements and the collected performance measurement reports. The apparatus further includes means for adjusting one or more RF resources and parameters of the femto node based on the indoors location classification of the femto node.

In yet another aspect, a computer program product includes a computer readable medium comprising code for causing at least one computer in a femto node to perform RF measurements of one or more neighboring femtocells and macrocells. The computer program product further includes code for causing the at least one computer to collect performance measurement reports from one or more mobile devices. The computer program product further includes code for causing the at least one computer to classify an indoors location of the femto node based on the performed RF measurements and the collected performance measurement reports. The computer program product further includes code for causing the at least one computer to adjust one or more RF resources and parameters of the femto node based on the indoors location classification of the femto node.

To the accomplishment of the foregoing and related ends, the one or more aspects comprise the features hereinafter fully described and particularly pointed out in the claims. The following description and the annexed drawings set forth in detail certain illustrative features of the one or more aspects. These features are indicative, however, of but a few of the various ways in which the principles of various aspects may be employed, and this description is intended to include all such aspects and their equivalents.

### BRIEF DESCRIPTION OF THE DRAWINGS

The disclosed aspects will hereinafter be described in conjunction with the appended drawings, provided to illustrate and not to limit the disclosed aspects, wherein like designations denote like elements.

FIG. 1 is a block diagram of an example wireless communication system in a building environment.

FIG. 2 is a block diagram of an example system for classifying a location of a femto node according to one aspect.

FIG. 3 is a flow chart of an example methodology for classifying a location of a femto node according to one aspect.

FIG. 4 is a flow chart of an example methodology for classifying a location of a femto node according to another aspect.

FIG. 5 is a block diagram of an example system for classifying a location of a femto node according to one aspect.

FIG. 6 is a block diagram of an example wireless communication system in accordance with various aspects set forth herein.

FIG. 7 is an illustration of an example wireless network environment that can be employed in conjunction with the various systems and methods described herein.

FIG. 8 illustrates an example wireless communication system, configured to support a number of devices, in which the aspects herein can be implemented.

FIG. 9 is an illustration of an exemplary communication system to enable deployment of femto nodes within a network environment.

FIG. 10 illustrates an example of a coverage map having several defined tracking areas.

### DETAILED DESCRIPTION

In various aspects, systems and methods to classify an indoors location of a femtocell, such as being deep indoors or being next to a window or an external wall, and intelligently allocate/adjust RF resources and parameters of the femtocell based on the indoors location classification in order to optimize coverage of the femtocell and reduce interference with neighboring femtocells and macrocells. Various aspects will be described with reference to the drawings. In the following description, for purposes of explanation, numerous specific details are set forth in order to provide a thorough understanding of one or more aspects. It may be evident, however, that such aspect(s) may be practiced without these specific details. Furthermore, various aspects or features will be presented in terms of systems that may include a number of devices, components, modules, and the like. It is to be understood and appreciated that the various systems may include additional devices, components, modules, etc. and/or may not include all of the devices, components, modules etc. discussed in connection with the figures. A combination of these approaches may also be used.

The techniques described herein may be used for various wireless communication systems such as CDMA, TDMA, FDMA, OFDMA, SC-FDMA, WiFi carrier sense multiple access (CSMA), and other systems. The terms “system” and “network” are often used interchangeably. A CDMA system may implement a radio technology such as Universal Terrestrial Radio Access (UTRA), cdma2000, etc. UTRA includes Wideband-CDMA (W-CDMA) and other variants of CDMA. Further, cdma2000 covers IS-2000, IS-95 and IS-856 standards. A TDMA system may implement a radio technology such as Global System for Mobile Communications (GSM). An OFDMA system may implement a radio technology such as Evolved UTRA (E-UTRA), Ultra Mobile Broadband (UMB), IEEE 802.11 (Wi-Fi), IEEE 802.16 (WiMAX), IEEE 802.20, Flash-OFDM®, etc. UTRA and E-UTRA are part of Universal Mobile Telecommunication System (UMTS). 3GPP Long Term Evolution (LTE) is a release of UMTS that uses E-UTRA, which employs OFDMA on the downlink and SC-FDMA on the uplink. UTRA, E-UTRA, UMTS, LTE and GSM are described in documents from an organization named “3rd Generation Partnership Project” (3GPP). Additionally, cdma2000 and UMB are described in documents from an organization named “3rd Generation Partnership Project 2” (3GPP2). Further, such wireless communication systems may additionally include peer-to-peer (e.g., mobile-to-mobile) ad hoc network systems often using unpaired unlicensed spectrums, 802.xx wireless LAN, BLUETOOTH and any other short- or long-range, wireless communication techniques.

The wireless communication system(s) may include a plurality of base stations (BS) utilized for communicating with mobile devices(s). These base stations may include a high-power macro node and a low-power femto node. The femto node may also be referred to as a femtocell, an access point, a femto BS, a pico node, a micro node, a Node B, an evolved Node B (eNB), a home Node B (HNB) or home evolved Node B (HeNB), collectively referred to as H(e)NB, or some other terminology. These femto nodes are generally considered to be low-power base stations. For example, a low-power base station transmits at a relatively low power as compared to a macro base station associated with a wireless wide area network (WWAN). As such, the coverage area of the low power femto node (e.g., femtocell) can be substantially smaller than the coverage area of a macro node (e.g., macrocell).

As generally known in the art, a mobile device can also be called a system, device, subscriber unit, subscriber station, mobile station, mobile, remote station, mobile terminal, remote terminal, access terminal, user terminal, terminal, communication device, user agent, user device, or user equipment (UE). A mobile device may be a cellular telephone, a satellite phone, a cordless telephone, a Session Initiation Protocol (SIP) phone, a wireless local loop (WLL) station, a personal digital assistant (PDA), a handheld device having wireless connection capability, a tablet, a computing device, or other processing devices connected via a wireless modem to one or more BS that provide cellular or wireless network access to the mobile device.

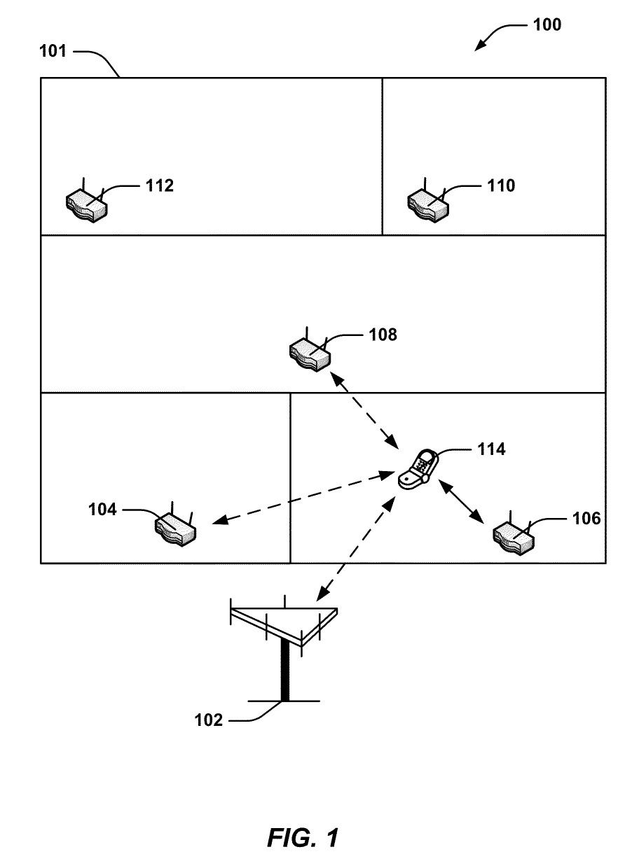

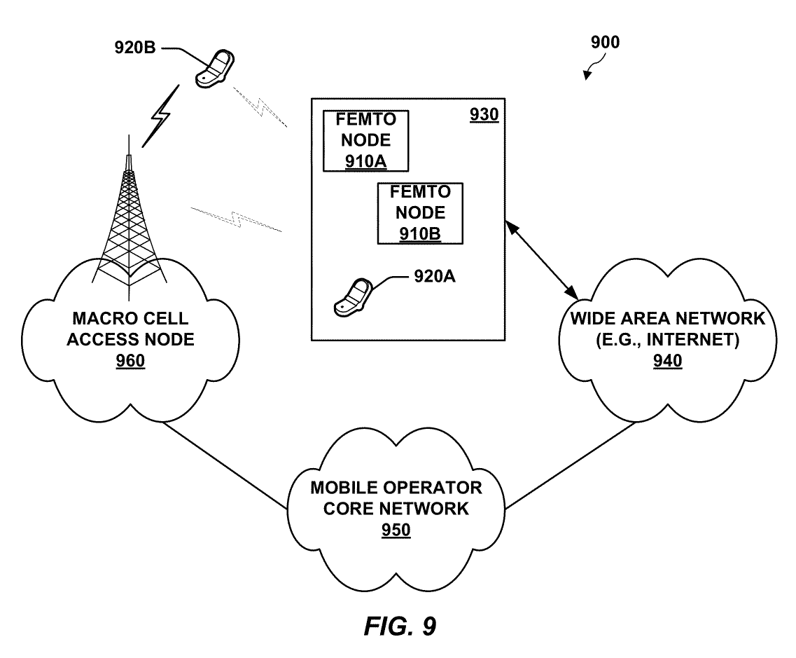

FIG. 1 shows an example wireless communication system 100 deployed in a multi-room building 101. System 100 includes an outside macro base station 102 that can provide one or more mobile devices 114 with access to a wireless network, as well as a plurality of femto nodes 104, 106, 108, 110, and 112 located inside the building, which can also provide wireless network access over a backhaul link with a mobile network over a broadband internet connection. In one example, femto nodes 104, 106, 108, 110, and/or 112 can be other types of low power base stations, a relay node, a device (e.g., communicating in peer-to-peer or ad-hoc mode with other devices), etc. Each femto node forms a femtocell (not shown in FIG. 1, but described in greater detail below with reference in FIG. 9). Moreover, system 100 comprises a plurality of mobile devices, such as device 114, which can be located inside one of the rooms of the building 101. The mobile device 114 may communicate wirelessly with one or more of the femto nodes 104, 106 and/or 108 as well as with the macro base station 102, which provided telecommunication services (e.g., voice, data, etc.) to the mobile device.

As shown in FIG. 1, some femto nodes, such as femto nodes 108 and 110, are located deep inside the building, while other femto nodes, such as femto nodes 104, 106 and 112 are located close to a window or an external wall. In open access femto deployment, femto node 106 may select a same RF channel as other femto nodes and macro nodes to achieve better frequency reuse, but this may lead to interference issues in high density femtocell and macrocell deployments. For example, if a transmit power of a femto node is calibrated improperly, the signal transmitted by the femto node may leak outside the desired coverage area and create interference to users served at other femtocells and macrocells. Also, the interference may occur for a short duration to passer-by users (e.g., a pedestrian or a user in an automobile) as the user moves closer to and then away from the femtocell. Therefore, it may be desirable for some femto nodes (e.g., femto nodes 104, 106 and 112 located near exterior walls of the building) to be assigned more resources (e.g., power, frequency or time) than those located deep within the building (e.g., femto nodes 108 and 110). This allows efficient indoor and outdoor coverage while mitigating interference caused to other femtocells and macrocells. To that end, the present systems and methods may classify an indoor location of femtocells 104, 106, 108, 110 and 112 into two or more classes, such as but not limited to a classification of deep indoors or close to an external wall. Based on this classification, according to an aspect of the present systems and methods, some femto nodes may shrink their coverage to avoid serving outdoor users and thus limiting interference, while other femto nodes may expand their coverage, e.g., to serve more indoor users.

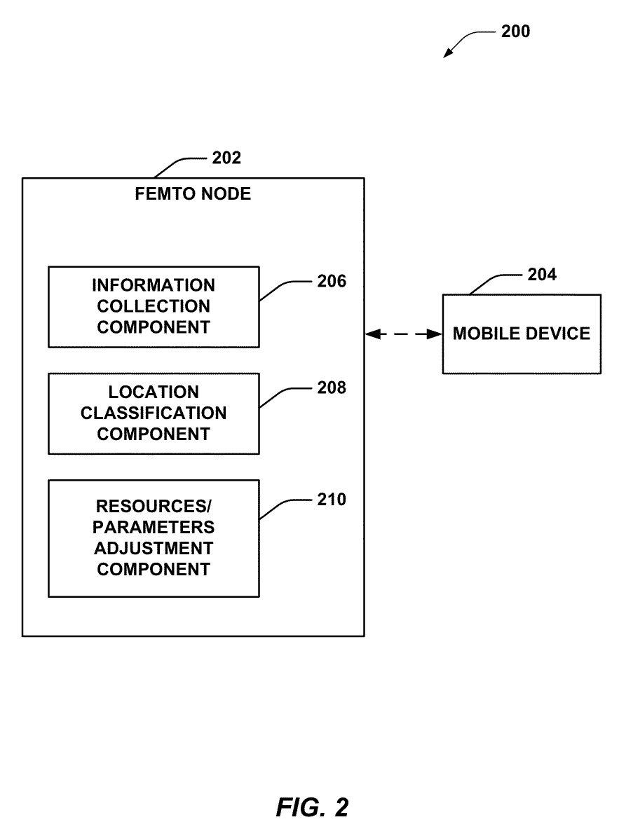

FIG. 2 illustrates an example system 200 that can be used to facilitate classification of femto node location and take appropriate actions based on the location classification. The system 200 includes a femto node 202 (e.g., one of femto nodes 104, 106, 108, 110 or 112 of FIG. 1) and a mobile device 204 (e.g., mobile device 114 in FIG. 1). In one aspect, the femto node 202 includes an information collection component 206, a location classification component 208, and a resource/parameters adjustment component 208. In various aspects, the components 206, 208 and 210 may be implemented not in a femto node 202, but in a central femto controller (not shown), which can be configured to collect network information from one or more femto nodes and mobile devices, classify a location of each femto node in the area, and perform adjustment of resources/parameters for the plurality of femto nodes based on the location of each femto node.

In one aspect, the information collection component 206 may collect signal strength measurements from neighboring macrocells and femtocells. For example, component 206 may use a network listen (NL) function to scan frequency spectrum for downlink transmissions from neighboring macrocells and femtocells, and measure signal strengths of the detected RF signals from other cells. In another aspect, the component 206 can also request one or more mobile devices (e.g., mobile device 204) to provide performance measurement reports to the femto node 202. In one aspect, the performance measurement report may include various key performance indicators (KPIs) and other data, such as a received signal strength indication (RSSI), a number of cell reselections, a number and type of handovers (e.g., intra-frequency, inter-frequency, inter-RAT, handovers to/from macrocell, handovers to/from femtocells), a number of call drops, average uplink and downlink interference measurements, and other performance and mobility parameters. In one aspect, the performance measurement reports may be sent over the air to the femto node 202 via air-interface messages, application-level messages or other communication mechanism.

In one aspect, the location classification component 208 is configured to classify a location of the femto node 202, such as, for example, a classification of deep indoors or a classification of close to an exterior wall within a building or user premises, based on the information collected by the component 206. Based on the RF measurements from neighboring cells and performance measurement reports from one or more mobile devices, component 208 can identify if the femto node 202 is located deep inside the building or closer to an external wall. For example, if the average macro signal strength reported by one or more mobile devices 204 (e.g., cumulative distribution function (CDF) of received signal code power (RSCP)) is greater than a signal strength (e.g., RSCP) measured by the NL function of femto node 202, then the femto node 202 may be considered to be located deep indoors. On the other hand, if an average macro signal strength reported by one or more mobile devices 204 is less than the signal strength (e.g., RSCP) measured by femto node 202, then the femto node 202 may be considered to be located closer to the exterior wall of the building.

In another aspect, the location classification component 208 can be configured to monitor reselections/handovers from one or more mobile devices located outdoors, where such mobile devices may be moving at a high speed (e.g., 40 mph or higher). For example, if reselections or handovers occur at low path loss values, then component 206 may conclude that the femto node 202 is located closer to the exterior wall.

In yet another aspect, the location classification component 208 can obtain user- or network-specified location information. For example, femto node location within a premises can be specified by the user or technician through a user interface (e.g., a graphical user interface (GUI)) provided by configuration software of the femto node. Alternatively, the information about a location of a femto node may be specified remotely through a operation administration and management (OAM) protocol associated with the femto node.

In other aspects, different methods known to those of ordinary skill in the art of wireless communications can be used for determining a location of the femto node.

In one aspect, the resources/parameters adjustment component 210 may be configured to automatically select/adjust a transmit power, an RF channel and/or a band allocation, and/or other femtocell resources and parameters to optimize coverage of the femto node and reduce interference with other cells based on the location classification of the femto node. For example, a femto node located near an exterior wall of a premises can use more network resources (e.g., transmitter power, RF channels/bands and transmission time slots) than a femto node located deep within the premises, because the femto node located closer to the exterior of the premises may serve more mobile devices than the femto node located deeper inside the premises. Furthermore, according to the present aspects, additional parameters such as a rise-over-thermal (ROT), and mobility and random access channel (RACH) parameters, may be adjusted according to the location classification of the femto node. For example, if the femto node is deep within the premises, then the ROT may be set higher and mobility parameters, including cell reselection and handover parameters, may be set such that a mobile device is not sticky (e.g., does not handover to that femto node easily). On the other hand, if the femto node is closer to an exterior wall, then the mobility parameters can be made sticky to handle coverage edge users, and the RACH parameters can be set high to allow successful decoding of the initial attempts by fast moving mobile devices. This configuration allows efficient indoor and outdoor coverage while mitigating interference caused to other cells. In an aspect, for example, typical cell reselection parameters may include, but are not limited to, one or more of Qhyst, Qqualmin, Qoffset, Qreselection, HCS, and the like. Further, in an aspect, typical handover parameters may include, but are not limited to, one or more of ABS (Almost Blank Subframes) configuration, Hysteresis, Time-to-trigger (TTT), cell individual offset, event offset (Ea3-offset), filter coefficient, frequency offset, and the like.

In an aspect, one advantage of the femto node location classification as described herein in the indoor environment may be mitigating pilot pollution. Particularly, after classification, indoor femto nodes could transmit at lower power to provide coverage to indoor apartment users while outdoor femto nodes may provide coverage to a larger geographic area. This configuration may reduce regions of pilot pollution (compared to the case when all femto nodes transmit at the same high power).

In another aspect, an advantage of the femto node location classification may be reduced number of handovers. Particularly, if the transmit power of a femto node is calibrated improperly, then the signals transmitted by the femto node may leak outside the desired coverage area and create interference to users served by neighboring cells. Also, the interference may occur for a short duration to passer-by users (e.g., a pedestrian user or a user in an automobile) as the user moves closer to and then away from the indoor femto nodes. The location classification mechanism described herein allows femto nodes located closer to the outside walls of the building to shrink their coverage area to avoid serving outdoor mobile users, thus reducing the number of handovers to outdoor users.

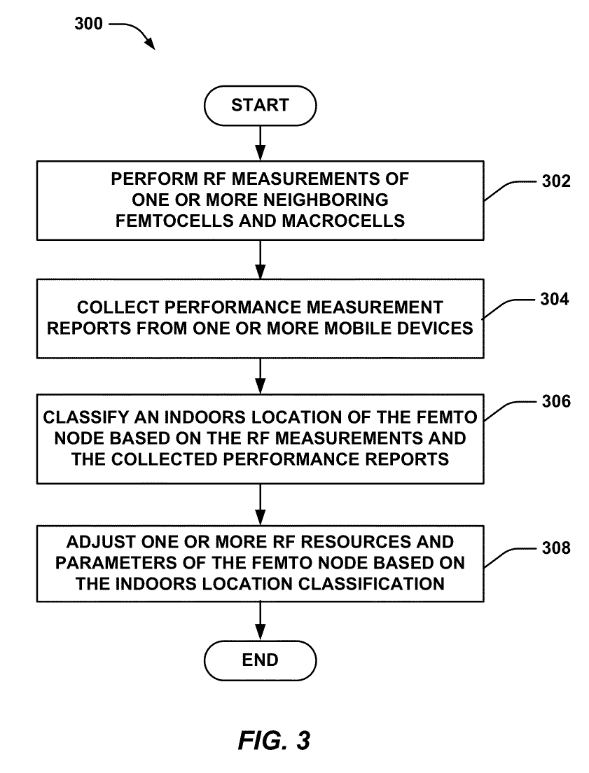

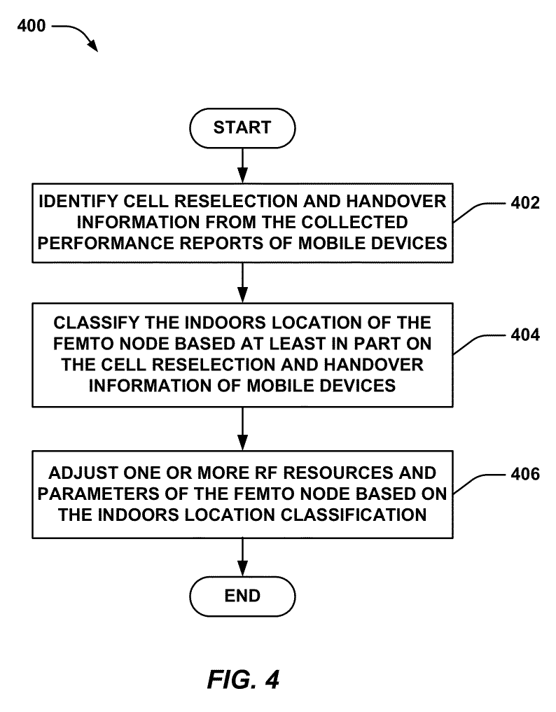

FIGS. 3 and 4 show example methodologies for classifying location of a femto node or femtocell inside a building and adjusting resources and parameters of the femto node based on a location classification. The example methodologies 300 and 400 may be defined in instructions stored on a femto node, such as femto node 202 of FIG. 2, or one or more components thereof, and executed by a processor to perform the described acts. While, for purposes of simplicity of explanation, the methodologies are shown and described as a series of acts, it is to be understood and appreciated that these methodologies is not limited by the order of acts, as some acts may, in accordance with one or more embodiments, occur in different orders and/or concurrently with other acts from that shown and described herein. For example, it is to be appreciated that a methodology could alternatively be represented as a series of interrelated states or events, such as in a state diagram. Moreover, not all illustrated acts may be required to implement a methodology in accordance with one or more embodiments.

Turning to FIG. 3, at step 302, the method 300 includes performing RF measurements of one or more neighboring femtocells and macrocells. For example, in an aspect, the femto node 202 may include information collection component 206 that performs the aforementioned RF measurements. At step 304, the method 300 includes collecting performance measurement reports from one or more mobile devices 204. For example, in an aspect, the information collection component 206 may collect this information from mobile devices. At step 306, the method 300 includes classifying an indoors location of the femto node, as deep indoor or closer to exterior walls of the premises, by, for example, comparing RF measurements of neighboring cells with the performance measurement reports. For example, in an aspect, the femto node 202 may include location classification component 208 that may perform the aforementioned classification process. At step 308, the method 300 includes adjusting one or more RF resources and parameters of the femto node based on the indoors location classification of the femto node. For example, in an aspect, the femto node 202 may include resources/parameters adjustment component 210 that adjusts/optimizes femtocell transmit power, an RF channel and/or band and other femto node resources and parameters to optimize a femtocell coverage and reduce interference.

Turning to FIG. 4, at step 402, the method 400 includes identifying cell reselection and handover information from the collected performance measurement reports from the one or more mobile devices. For example, in an aspect, the femto node 202 may include information collection component 206 that identifies the information about reselections and/or handovers of mobile devices from their performance measurement reports. At step 404, the method 400 includes classifying indoors location of the femto node, as deep indoor or closer to an exterior wall, based on the analysis of the information about reselections and/or handovers of one or more mobile devices. For example, in an aspect, the femto node 202 may include location classification component 208 that may perform the aforementioned classification process. At step 406, the method 400 includes adjusting a transmit power, an RF channel and/or band and other resources and parameters of the femto node to optimize cell coverage and reduce interference based on the indoors location classification of the femto node. For example, in an aspect, the femto node 202 may include resources/parameters adjustment component 210 that performs the aforementioned adjustment/optimization processes based on the indoors location classification of the femto node.

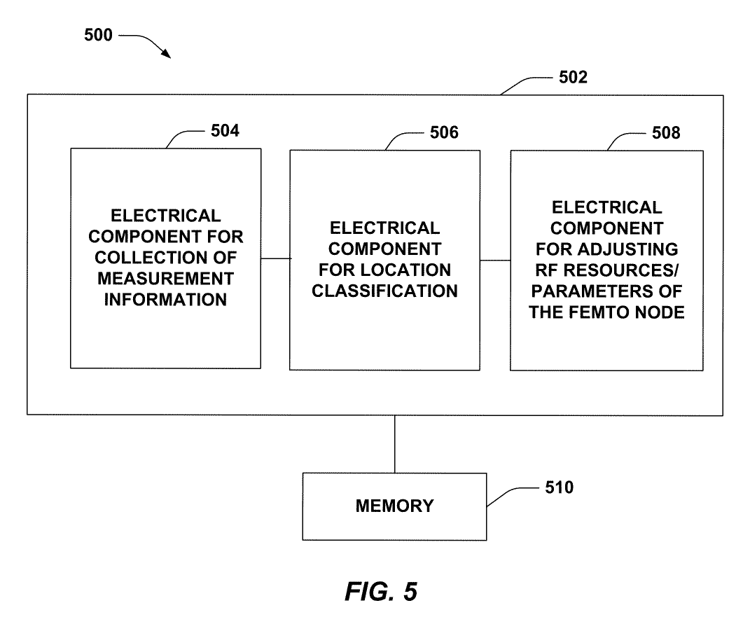

FIG. 5 illustrates a system for classifying an indoors location of a femto node or femtocell. For example, the system 500 can reside at least partially within a femto node, such as femto node 202 of FIG. 2. It is to be appreciated that system 500 is represented as including functional blocks, which can be functional blocks that represent functions implemented by a processor, software, or combination thereof (e.g., firmware). System 500 includes a logical grouping 502 of electrical components that can act in conjunction. For instance, in one aspect, logical grouping 502 can include an electrical component 504 for collecting RF measurements form neighboring femtocells and macrocells and performance measurement reports from mobile devices. In addition, logical grouping 502 can include an electrical component 506 for classifying location of the femto node as deep indoor or closer to exterior walls of the premises, based on the information collected by component 504. Furthermore, logical grouping 502 can include an electrical component 508 for adjusting resources and parameters, such as a transmit power, an RF channel and/or band, based on the location classification of the femto node, in order to optimize coverage and reduce interference.

Additionally, system 500 can include a memory 510 that retains instructions for executing functions associated with the electrical components 504, 506 and 508. While shown as being external to memory 510, it is to be understood that one or more of the electrical components 504, 506 and 508 can exist within memory 510. In one example, electrical components 504, 506 and 508 can comprise at least one processor, or each electrical component 504, 506 and 508 can be a corresponding module of at least one processor. Moreover, in an additional or alternative example, electrical components 504, 506 and 508 can be a computer program product comprising a computer readable medium, where each electrical component 504, 506 and 508 can be corresponding code.

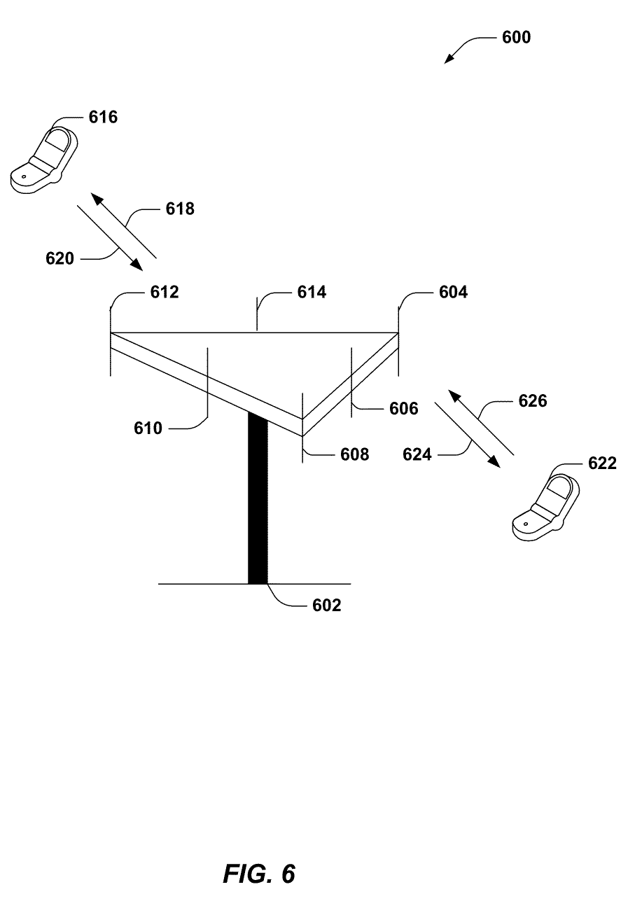

Referring now to FIG. 6, a wireless communication system 600 in which systems and methods for classifying an indoors location of a femtocell or femto node. System 600 comprises a base station 602, which may be a femto node, such as femto node 202 of FIG. 2 or system 500 of FIG. 5, and may include the components and implement the functions described above with respect to FIGS. 1-5. In one aspect, base station 602 can include multiple antenna groups. For example, one antenna group can include antennas 604 and 606, another group can comprise antennas 608 and 610, and an additional group can include antennas 612 and 614. Two antennas are illustrated for each antenna group; however, more or fewer antennas can be utilized for each group. Base station 602 can additionally include a transmitter chain and a receiver chain, each of which can in turn comprise a plurality of components associated with signal transmission and reception (e.g., processors, modulators, multiplexers, demodulators, demultiplexers, antennas, etc.), as is appreciated.

Base station 602 can communicate with one or more mobile devices such as mobile device 616 and mobile device 622, which can include mobile device 204 of FIG. 2; however, it is to be appreciated that base station 602 can communicate with substantially any number of mobile devices similar to mobile devices 616 and 622. Mobile devices 616 and 622 can be, for example, cellular phones, smart phones, laptops, handheld communication devices, handheld computing devices, satellite radios, global positioning systems, PDAs, and/or any other suitable device for communicating over wireless communication system 600. As depicted, mobile device 616 is in communication with antennas 612 and 614, where antennas 612 and 614 transmit information to mobile device 616 over a forward link 618 and receive information from mobile device 616 over a reverse link 620. Moreover, mobile device 622 is in communication with antennas 604 and 606, where antennas 604 and 606 transmit information to mobile device 622 over a forward link 624 and receive information from mobile device 622 over a reverse link 626. In a frequency division duplex (FDD) system, forward link 618 can utilize a different frequency band than that used by reverse link 620, and forward link 624 can employ a different frequency band than that employed by reverse link 626, for example. Further, in a time division duplex (TDD) system, forward link 618 and reverse link 620 can utilize a common frequency band and forward link 624 and reverse link 626 can utilize a common frequency band.

Each group of antennas and/or the area in which they are designated to communicate can be referred to as a sector of base station 602. For example, antenna groups can be designed to communicate to mobile devices in a sector of the areas covered by base station 602. In communication over forward links 618 and 624, the transmitting antennas of base station 602 can utilize beamforming to improve signal-to-noise ratio of forward links 618 and 624 for mobile devices 616 and 622. Also, while base station 602 utilizes beamforming to transmit to mobile devices 616 and 622 scattered randomly through an associated coverage, mobile devices in neighboring cells can be subject to less interference as compared to a base station transmitting through a single antenna to all its mobile devices. Moreover, mobile devices 616 and 622 can communicate directly with one another using a peer-to-peer or ad hoc technology as depicted. According to an example, system 600 can be a multiple-input multiple-output (MIMO) communication system.

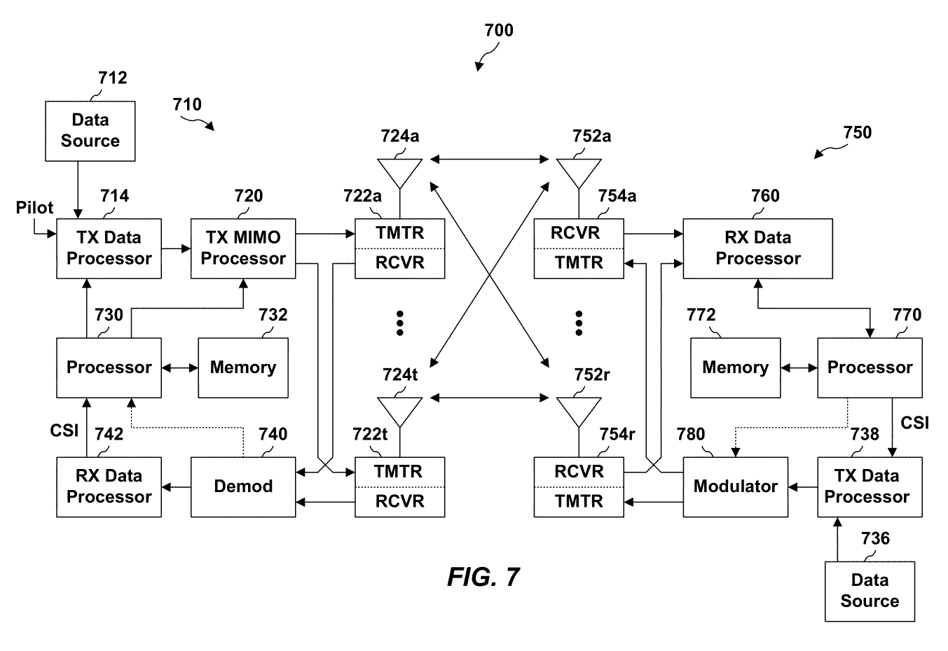

FIG. 7 shows an example wireless communication system 700 in which systems and methods for classifying indoors location of a femto node or femtocell can be implemented. The wireless communication system 700 depicts one base station 710, which can include a femto node, such as femto node 202 of FIG. 2, and one mobile device 750, such as mobile device 204 of FIG. 2. However, it is to be appreciated that system 700 can include more than one base station and/or more than one mobile device, wherein additional base stations and/or mobile devices can be substantially similar or different from example base station 710 and mobile device 750 described below. In addition, it is to be appreciated that base station 710 and/or mobile device 750 can employ the systems (FIGS. 1, 2, 5 and 6) and/or methods (FIGS. 3 and 4) described herein to facilitate wireless communication there between. For example, components or functions of the systems and/or methods described herein can be part of a memory 732 and/or 772 or processors 730 and/or 770 described below, and/or can be executed by processors 730 and/or 770 to perform the disclosed functions.

At base station 710, traffic data for a number of data streams is provided from a data source 712 to a transmit (TX) data processor 714. According to an example, each data stream can be transmitted over a respective antenna. TX data processor 714 formats, codes, and interleaves the traffic data stream based on a particular coding scheme selected for that data stream to provide coded data.

The coded data for each data stream can be multiplexed with pilot data using orthogonal frequency division multiplexing (OFDM) techniques. Additionally or alternatively, the pilot symbols can be frequency division multiplexed (FDM), time division multiplexed (TDM), or code division multiplexed (CDM). The pilot data is typically a known data pattern that is processed in a known manner and can be used at mobile device 750 to estimate channel response. The multiplexed pilot and coded data for each data stream can be modulated (e.g., symbol mapped) based on a particular modulation scheme (e.g., binary phase-shift keying (BPSK), quadrature phase-shift keying (QPSK), M-phase-shift keying (M-PSK), M-quadrature amplitude modulation (M-QAM), etc.) selected for that data stream to provide modulation symbols. The data rate, coding, and modulation for each data stream can be determined by instructions performed or provided by processor 730.

The modulation symbols for the data streams can be provided to a TX MIMO processor 720, which can further process the modulation symbols (e.g., for OFDM). TX MIMO processor 720 then provides N_{T} modulation symbol streams to N_{T} transmitters (TMTR) 722a through 722t. In various embodiments, TX MIMO processor 720 applies beamforming weights to the symbols of the data streams and to the antenna from which the symbol is being transmitted.

Each transmitter 722 receives and processes a respective symbol stream to provide one or more analog signals, and further conditions (e.g., amplifies, filters, and upconverts) the analog signals to provide a modulated signal suitable for transmission over the MIMO channel. Further, N_{T} modulated signals from transmitters 722a through 722t are transmitted from N_{T} antennas 724a through 724t, respectively.

At mobile device 750, the transmitted modulated signals are received by N_{R} antennas 752a through 752r and the received signal from each antenna 752 is provided to a respective receiver (RCVR) 754a through 754r. Each receiver 754 conditions (e.g., filters, amplifies, and downconverts) a respective signal, digitizes the conditioned signal to provide samples, and further processes the samples to provide a corresponding “received” symbol stream.

An RX data processor 760 can receive and process the N_{R} received symbol streams from N_{R} receivers 754 based on a particular receiver processing technique to provide N_{T} “detected” symbol streams. RX data processor 760 can demodulate, deinterleave, and decode each detected symbol stream to recover the traffic data for the data stream. The processing by RX data processor 760 is complementary to that performed by TX MIMO processor 720 and TX data processor 714 at base station 710.

The reverse link message can comprise various types of information regarding the communication link and/or the received data stream. The reverse link message can be processed by a TX data processor 738, which also receives traffic data for a number of data streams from a data source 736, modulated by a modulator 780, conditioned by transmitters 754a through 754r, and transmitted back to base station 710.

At base station 710, the modulated signals from mobile device 750 are received by antennas 724, conditioned by receivers 722, demodulated by a demodulator 740, and processed by a RX data processor 742 to extract the reverse link message transmitted by mobile device 750. Further, processor 730 can process the extracted message to determine which precoding matrix to use for determining the beamforming weights.

Processors 730 and 770 can direct (e.g., control, coordinate, manage, etc.) operation at base station 710 and mobile device 750, respectively. Respective processors 730 and 770 can be associated with memory 732 and 772 that store program codes and data. Processors 730 and 770 can also perform functionalities described herein to support selecting a paging area identifier for one or more femto nodes.

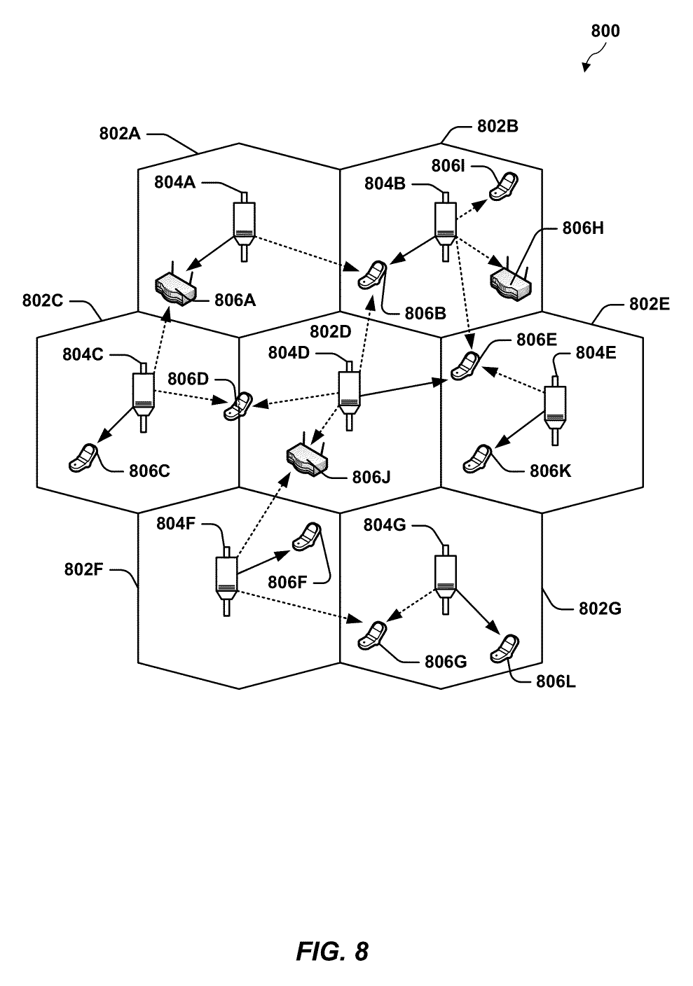

FIG. 8 illustrates a wireless communication system 800, configured to support a number of users, in which systems and methods for classifying indoors location of a femto node or femtocell can be implemented. The system 800 provides communication for multiple cells 802, such as, for example, macro cells 802A-802G, with each cell being serviced by a corresponding access node 804 (e.g., access nodes 804A-804G). As shown in FIG. 8, mobile devices 806 (e.g., mobile devices 806A-806L) can be dispersed at various locations throughout the system over time. Each mobile device 806 can communicate with one or more access nodes 804 on a forward link (FL) and/or a reverse link (RL) at a given moment, depending upon whether the mobile device 806 is active and whether it is in soft handoff, for example. The wireless communication system 800 can provide service over a large geographic region. In some aspects, some of the mobile devices 806, such as devices 806A, 806H, and 806J, may be femto nodes, such as nodes 102 or 202 or system 500, and may include the components and implement the functions described above with respect to FIGS. 1-5.

FIG. 9 illustrates an exemplary communication system 900 where one or more femto nodes, such as femto node 202 of FIG. 2, are deployed within a network environment. Specifically, the system 900 includes multiple femto nodes 910A and 910B (e.g., femtocell nodes or H(e)NB) installed in a relatively small scale network environment (e.g., in one or more user residences 930), which, in one aspect, may correspond to femto nodes 104, 106, 108, 110, and 112 of FIG. 1. Each femto node 910 can be coupled to a wide area network 940 (e.g., the Internet) and a mobile operator core network 950 via a digital subscriber line (DSL) router, a cable modem, a wireless link, or other connectivity means (not shown). As will be discussed below, each femto node 910 can be configured to serve associated mobile devices 920 (e.g., mobile device 920A) and, optionally, alien mobile devices 920 (e.g., mobile device 920B). In other words, access to femto nodes 910 can be restricted such that a given mobile device 920 can be served by a set of designated (e.g., home) femto node(s) 910 but may not be served by any non-designated femto nodes 910 (e.g., a neighbor's femto node).

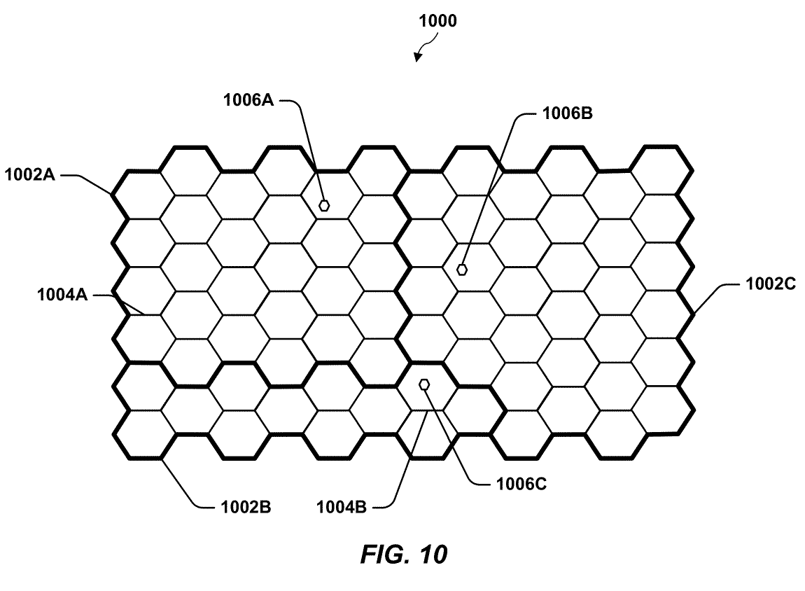

FIG. 10 illustrates an example of a coverage map 1000 where several tracking areas 1002 (or routing areas or location areas) are defined, each of which includes several macro coverage areas 1004. Here, areas of coverage associated with tracking areas 1002A, 1002B, and 1002C are delineated by the wide lines and the macro coverage areas 1004 are represented by the hexagons. The tracking areas 1002 also include femto coverage areas 1006 corresponding to respective femto nodes, such as a femto node 202 of FIG. 2, and which may include the components and implement the functions described above with respect to FIGS. 1-5. In this example, each of the femto coverage areas 1006 (e.g., femto coverage area 1006C) is depicted within a macro coverage area 1004 (e.g., macro coverage area 1004B). It should be appreciated, however, that a femto coverage area 1006 may not lie entirely within a macro coverage area 1004. In practice, a large number of femto coverage areas 1006 can be defined with a given tracking area 1002 or macro coverage area 1004. Also, one or more pico coverage areas (not shown) can be defined within a given tracking area 1002 or macro coverage area 1004.

Referring again to FIG. 9, the owner of a femto node 910 can subscribe to mobile service, such as, for example, 3G mobile service, offered through the mobile operator core network 950. In another example, the femto node 910 can be operated by the mobile operator core network 950 to expand coverage of the wireless network. In addition, a mobile device 920 can be capable of operating both in macro environments and in smaller scale (e.g., residential) network environments. Thus, for example, depending on the current location of the mobile device 920, the mobile device 920 can be served by a macro cell access node 960 or by any one of a set of femto nodes 910 (e.g., the femto nodes 910A and 910B that reside within a corresponding user residence 930). For example, when a subscriber is outside his home, he is served by a standard macro cell access node (e.g., node 960) and when the subscriber is at home, he is served by a femto node (e.g., node 910A). Here, it should be appreciated that a femto node 910 can be backward compatible with existing mobile devices 920.

A femto node 910 can be deployed on a single frequency or, in the alternative, on multiple frequencies. Depending on the particular configuration, the single frequency or one or more of the multiple frequencies can overlap with one or more frequencies used by a macro cell access node (e.g., node 960). In some aspects, an mobile device 920 can be configured to connect to a preferred femto node (e.g., the home femto node of the mobile device 920) whenever such connectivity is possible. For example, whenever the mobile device 920 is within the user's residence 930, it can communicate with the home femto node 910.

In some aspects, if the mobile device 920 operates within the mobile operator core network 950 but is not residing on its most preferred network (e.g., as defined in a preferred roaming list), the mobile device 920 can continue to search for the most preferred network (e.g., femto node 910) using a Better System Reselection (BSR), which can involve a periodic scanning of available systems to determine whether better systems are currently available, and subsequent efforts to associate with such preferred systems. Using an acquisition table entry (e.g., in a preferred roaming list), in one example, the mobile device 920 can limit the search for specific band and channel. For example, the search for the most preferred system can be repeated periodically. Upon discovery of a preferred femto node, such as femto node 910, the mobile device 920 selects the femto node 910 for camping within its coverage area.

A femto node can be restricted in some aspects. For example, a given femto node can only provide certain services to certain mobile devices. In deployments with so-called restricted (or closed) association, a given mobile device can only be served by the macro cell mobile network and a defined set of femto nodes (e.g., the femto nodes 910 that reside within the corresponding user residence 930). In some implementations, a femto node can be restricted to not provide, for at least one mobile device, at least one of: signaling, data access, registration, paging, or service.

In some aspects, a restricted femto node (which can also be referred to as a Closed Subscriber Group H(e)NB) is one that provides service to a restricted provisioned set of mobile devices. This set can be temporarily or permanently extended as necessary. In some aspects, a Closed Subscriber Group (CSG) can be defined as the set of access nodes (e.g., femto nodes) that share a common access control list of mobile devices. A channel on which all femto nodes (or all restricted femto nodes) in a region operate can be referred to as a femto channel.

Various relationships can thus exist between a given femto node and a given mobile device. For example, from the perspective of a mobile device, an open femto node can refer to a femto node with no restricted association. A restricted femto node can refer to a femto node that is restricted in some manner (e.g., restricted for association and/or registration). A home femto node can refer to a femto node on which the mobile device is authorized to access and operate on. A guest femto node can refer to a femto node on which a mobile device is temporarily authorized to access or operate on. An alien femto node can refer to a femto node on which the mobile device is not authorized to access or operate on, except for perhaps emergency situations (e.g., 911 calls).

From a restricted femto node perspective, a home mobile device can refer to an mobile device that authorized to access the restricted femto node. A guest mobile device can refer to a mobile device with temporary access to the restricted femto node. An alien mobile device can refer to a mobile device that does not have permission to access the restricted femto node, except for perhaps emergency situations, for example, 911 calls (e.g., an access terminal that does not have the credentials or permission to register with the restricted femto node).

For convenience, the disclosure herein describes various functionalities in the context of a femto node or femtocell. It should be appreciated, however, that a pico node can provide the same or similar functionality as a femto node, but for a larger coverage area. For example, a pico node can be restricted, a home pico node can be defined for a given mobile device, and so on.

The various illustrative logics, logical blocks, modules, components, and circuits described in connection with the embodiments disclosed herein may be implemented or performed with a general purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general-purpose processor may be a microprocessor, but, in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration. Additionally, at least one processor may comprise one or more modules operable to perform one or more of the steps and/or actions described above. An exemplary storage medium may be coupled to the processor, such that the processor can read information from, and write information to, the storage medium. In the alternative, the storage medium may be integral to the processor. Further, in some aspects, the processor and the storage medium may reside in an ASIC. Additionally, the ASIC may reside in a user terminal. In the alternative, the processor and the storage medium may reside as discrete components in a user terminal.

In one or more aspects, the functions, methods, or algorithms described may be implemented in hardware, software, firmware, or any combination thereof. If implemented in software, the functions may be stored or transmitted as one or more instructions or code on a computer-readable medium, which may be incorporated into a computer program product. Computer-readable media includes both computer storage media and communication media including any medium that facilitates transfer of a computer program from one place to another. A storage medium may be any available media that can be accessed by a computer. By way of example, and not limitation, such computer-readable media can comprise RAM, ROM, EEPROM, CD-ROM or other optical disk storage, magnetic disk storage or other magnetic storage devices, or any other medium that can be used to carry or store desired program code in the form of instructions or data structures and that can be accessed by a computer. Also, substantially any connection may be termed a computer-readable medium. For example, if software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. Disk and disc, as used herein, includes compact disc (CD), laser disc, optical disc, digital versatile disc (DVD), floppy disk and blu-ray disc where disks usually reproduce data magnetically, while discs usually reproduce data optically with lasers. Combinations of the above should also be included within the scope of computer-readable media.

As used in this application, the terms “component,” “module,” “system” and the like are intended to include a computer-related entity, such as but not limited to hardware, firmware, a combination of hardware and software, software, or software in execution. For example, a component may be, but is not limited to being, a process running on a processor, a processor, an object, an executable, a thread of execution, a program, and/or a computer. By way of illustration, both an application running on a computing device and the computing device can be a component. One or more components can reside within a process and/or thread of execution and a component may be localized on one computer and/or distributed between two or more computers. In addition, these components can execute from various computer readable media having various data structures stored thereon. The components may communicate by way of local and/or remote processes such as in accordance with a signal having one or more data packets, such as data from one component interacting with another component in a local system, distributed system, and/or across a network such as the Internet with other systems by way of the signal.

Moreover, the term “or” is intended to mean an inclusive “or” rather than an exclusive “or.” That is, unless specified otherwise, or clear from the context, the phrase “X employs A or B” is intended to mean any of the natural inclusive permutations. That is, the phrase “X employs A or B” is satisfied by any of the following instances: X employs A; X employs B; or X employs both A and B. In addition, the articles “a” and “an” as used in this application and the appended claims should generally be construed to mean “one or more” unless specified otherwise or clear from the context to be directed to a singular form.

While the foregoing disclosure discusses illustrative aspects and/or embodiments, it should be noted that various changes and modifications could be made herein without departing from the scope of the described aspects and/or embodiments as defined by the appended claims. Furthermore, although elements of the described aspects and/or embodiments may be described or claimed in the singular, the plural is contemplated unless limitation to the singular is explicitly stated. Additionally, all or a portion of any aspect and/or embodiment may be utilized with all or a portion of any other aspect and/or embodiment, unless stated otherwise.

1. A method for wireless communication, comprising:
performing, by a femto node, radio frequency (RF) measurements of one or more neighboring femtocells and macrocells;
collecting, by the femto node, performance measurement reports from one or more mobile devices;
classifying an indoors location of the femto node based on the performed RF measurements and the collected performance measurement reports; and
adjusting one or more RF resources and parameters of the femto node based on the indoors location classification of the femto node.

2. The method of claim 1, wherein classifying the indoors location of the femto node includes classifying the location of the femto node as located deep indoors or as located closer to an exterior wall.

3. The method of claim 1, wherein classifying the indoors location of the femto node includes comparing the RF measurements from the one or more neighboring femtocells and macrocells with the performance measurement reports from the one or more mobile devices.

4. The method of claim 1, wherein a performance measurement report from a mobile device includes one or more of a received signal strength indication (RSSI), a number of cell reselections, a number and type of handovers, a number of call drops, and average uplink and downlink interference measurements.

5. The method of claim 1, further comprising:
identifying cell reselection and handover information from the collected performance measurement reports from the one or more mobile devices; and
classifying the indoors location of the femto node based at least in part on the identified cell reselection and handover information.

6. The method of claim 1, wherein adjusting one or more RF resources and parameters of the femto node includes adjusting one or more of a femto node transmit power, an RF channel allocation, a number of transmission time slots, a rise-over-thermal (ROT), and one or more mobility and random access channel (RACH) parameters.

7. The method of claim 1, wherein performing RF measurements of the one or more neighboring femtocells and macrocells includes using a network listen (NL) function of the femto node to scan frequency spectrum for downlink transmissions from the one or more neighboring macrocells and femtocells.

8. A femto node apparatus for wireless communication, comprising:
an information collection component configured to perform radio frequency (RF) measurements of one or more neighboring femtocells and macrocells;
wherein the information collection component is further configured to collect performance measurement reports from one or more mobile devices;
a location classification component configured to classify an indoors location of the femto node based on the performed RF measurements and the collected performance measurement reports; and
an adjustment component configured to adjust one or more RF resources and parameters of the femto node based on the indoors location classification of the femto node.

9. The apparatus of claim 8, wherein to classify the indoors location of the femto node, the location classification component is further configured to classify the location of the femto node as located deep indoors or as located closer to an exterior wall.

10. The apparatus of claim 8, wherein to classify the indoors location of the femto node, the location classification component is further configured to compare the RF measurements from the one or more neighboring femtocells and macrocells with the performance measurement reports from the one or more mobile devices.

11. The apparatus of claim 8, wherein the performance measurement report from a mobile device includes one or more of a received signal strength indication (RSSI), a number of cell reselections, a number and type of handovers, a number of call drops, and average uplink and downlink interference measurements.

12. The apparatus of claim 8, wherein the location classification component further configured to:
identify cell reselection and handover information from the collected performance measurement reports from the one or more mobile devices; and
classify the indoors location of the femto node based at least in part on the identified cell reselection and handover information.

13. The apparatus of claim 8, wherein to adjust one or more RF resources and parameters of the femto node, the adjustment component is further configured to adjust one or more of a femto node transmit power, an RF channel allocation, a number of transmission time slots, a rise-over-thermal (ROT), and one or more mobility and random access channel (RACH) parameters.

14. The apparatus of claim 8, wherein to perform RF measurements of the one or more neighboring femtocells and macrocells, the information collection component is further configured to use a network listen (NL) function of the femto node to scan frequency spectrum for downlink transmissions from the one or more neighboring macrocells and femtocells.

15. A femto node apparatus for wireless communication, comprising:
means for performing radio frequency (RF) measurements of one or more neighboring femtocells and macrocells;
means for collecting performance measurement reports from one or more mobile devices;
means for classifying an indoors location of the femto node based on the performed RF measurements and collected performance measurement reports; and
means for adjusting one or more RF resources and parameters of the femto node based on the indoors location classification of the femto node.

16. The apparatus of claim 15, wherein the means for classifying the indoors location of the femto node includes means for classifying the location of the femto node as located deep indoors or as one located closer to an exterior wall.

17. The apparatus of claim 15, wherein the means for classifying the indoors location of the femto node includes means for comparing the RF measurements from the one or more neighboring femtocells and macrocells with the performance measurement reports from the one or more mobile devices.

18. The apparatus of claim 15, wherein a performance measurement report from a mobile device includes one or more of a received signal strength indication (RSSI), a number of cell reselections, a number and type of handovers, a number of call drops, and average uplink and downlink interference measurements.

19. The apparatus of claim 15, further comprising:
means for identifying cell reselection and handover information from the collected performance measurement reports from the one or more mobile devices; and
means for classifying the indoors location of the femto node based at least in part on the identified cell reselection and handover information.

20. The apparatus of claim 15, wherein the means for adjusting the one or more RF resources and parameters of the femto node includes means for adjusting one or more of a femto node transmit power, an RF channel allocation, a number of transmission time slots, a rise-over-thermal (ROT), and one or more mobility and random access channel (RACH) parameters.

21. The apparatus of claim 15, wherein the means for performing the RF measurements of one or more neighboring femtocells and macrocells includes means for using a network listen (NL) function of the femto node to scan frequency spectrum for downlink transmissions from one or more neighboring macrocells and femtocells.

22. A computer program product for wireless communication, comprising:
a computer-readable medium, comprising:
code for causing at least one computer in a femto node to perform radio frequency (RF) measurements of one or more neighboring femtocells and macrocells;
code for causing the at least one computer to collect performance measurement reports from one or more mobile devices;
code for causing the at least one computer to classify an indoors location of the femto node based on the performed RF measurements and the collected performance measurement reports; and
code for causing the at least one computer to adjust one or more RF resources and parameters of the femto node based on the indoors location classification of the femto node.

23. The computer program product of claim 22, wherein the code for causing the at least one computer to classify the indoors location of the femto node includes code for classifying the location of the femto node as located deep indoors or as located closer to an exterior wall.

24. The computer program product of claim 22, wherein the code for causing the at least one computer to classify the indoors location of the femto node includes code for comparing the RF measurements from the one or more neighboring femtocells and macrocells with the performance measurement reports from the one or more mobile devices.

25. The computer program product of claim 22, wherein a performance measurement report from a mobile device includes one or more of a received signal strength indication (RSSI), a number of cell reselections, a number and type of handovers, a number of call drops, and average uplink and downlink interference measurements.

26. The computer program product of claim 22, further comprising:
code for causing the at least one computer to identify cell reselection and handover information from the collected performance measurement reports from the one or more mobile devices; and
code for causing the at least one computer to classify the indoors location of the femto node based at least in part on the identified cell reselection and handover information.

27. The computer program product of claim 22, wherein the code for causing the at least one computer to adjust the one or more RF resources and parameters of the femto node includes code for adjusting one or more of a femto node transmit power, an RF channel allocation, a number of transmission time slots, a rise-over-thermal (ROT), and one or more mobility and random access channel (RACH) parameters.

28. The computer program product of claim 22, wherein the code for causing the at least one computer to perform RF measurements of the one or more neighboring femtocells and macrocells includes code for using a network listen (NL) function of the femto node to scan frequency spectrum for downlink transmissions from the one or more neighboring macrocells and femtocells.
